(19) United States
(12) Patent Application Publication
(10) Pub. No.: US 2022/0381590 A1
(43) Pub. Date: Dec. 1, 2022

(54) METHOD FOR AUTOMATICALLY DISPLAYING MEASUREMENT VALUES

(71) Applicant: ELPRO GMBH, Berlin (DE)

(72) Inventor: Wladimir DEGTJAREW, Berlin (DE)

(73) Assignee: ELPRO GMBH, Berlin (DE)

(21) Appl. No.: 17/773,626

(22) PCT Filed: Oct. 29, 2020
(86) PCT No.: PCT/EP2020/080406

§ 371 Date: May 2, 2022

(30) Foreign Application Priority Data
Oct. 30, 2019 (DE) 10 2019 129 384.7
Dec. 16, 2019 (DE) 10 2019 134 439.5

(51) Int. Cl. G01D 7/00; G01D 7/10

(52) U.S. Cl. CPC G01D 7/005; G01D 7/10

(57) ABSTRACT

The invention relates to a method for automatically displaying measurement values, having the method steps of transmitting a number of measurement value groups detected by a sensor system, wherein each measurement value group has n variables; ascertaining an optical value range for the display of the n-th variables; transforming the values of the n-th variables of the measurement value groups into optical values from the optical value range; displaying variables 1 to n−1 of the measurement value groups in a coordinate system with n−1 dimensions; and displaying the points of the measurement value groups in the optical values assigned to the n-th variables of the measurement value groups.

The invention relates to a method for automatically displaying measurement values with the method steps of transmitting a number of measurement value groups detected by a sensor system, each measurement value group having n variables; ascertaining an optical value range for the display of the n-th variables; and displaying variables 1 to n−1 of the measurement value groups in a coordinate system with n−1 dimensions.

### PRIOR ART

It is known to enter measurement values of a system into a multidimensional coordinate system and thus to clearly display the measurement values. The coordinate system can have two or three dimensions and can use Cartesian coordinates or spherical coordinates.

A corresponding method is presented, for example, in patent specification DE 10 2007 046 542 B2. However, each measurement value can only be displayed as a function of three variables due to the limitation of representation in a three-axis coordinate system. However, it is often desirable to display a measurement value as a function of more variables, for example to enable the measurement value to be evaluated for relevance. However, previous methods do not allow for this.

It is therefore the object of the present invention to provide a method for automatically displaying measurement values, so that a user can quickly and reliably assess the relevance of the measurement values detected by the monitored system.

This object is achieved by means of the method according to claim 1. Additional advantageous embodiments of the invention are set out in the dependent claims.

The method according to the invention for automatically displaying measurement values has five method steps: In the first method step, a number of measurement value groups that are detected by a sensor system are transmitted. In particular, each measurement value group has a number of n variables, each of the n variables representing a different physical measured variable with different physical units in each case.

Within the meaning of the invention, measurement data are raw data supplied by a sensor system and/or recorded values which are determined on the basis of raw data supplied by a sensor system. Examples of such measurement data are volume, energy, and time. Measurement value groups are measurement values that also have one or more associated values supplied from outside the sensor system. The measurement value groups can likewise and/or additionally be characteristic numbers determined from measurement values. A set of metrics can be, for example, the volume of a gas, the energy used to compress the gas, the cost of energy, and the time taken to compress. Variables are measurement data, measurement value groups, and/or other values that are generated within and/or outside the sensor system.

In the second method step, a value range is defined in which the n-th variable of the measurement value groups is displayed optically. The optical value range can be determined automatically by an algorithm, by a user specification, or by a combination of both possibilities. In the third method step, the values of the n-th variables of the measurement value groups are transformed into the optical values specified in method step 2. In the fourth method step, variables from 1 to n−1 of the measurement value groups are displayed in a coordinate system that has n−1 dimensions. In the fifth method step, the optical values of the points in the measurement value groups are displayed with their optical values. For the purposes of this document, the number n indicates a natural number greater than 2, preferably greater than 3.

The method according to the invention enables a user to automatically display n-dimensional measurement values in an n−1-dimensional coordinate system; in addition, the n-th dimension is automatically displayed as an optical value range. This makes it possible for the first time to show a correlation of more variables than the coordinate system has dimensions. The advantage of the method is that it can put completely different measurement data in context and output the data graphically. In particular, the graphical display of a plurality of variables in a diagram reveals connections to the user more so in a surprising way than when the data are considered alone or as a result of several displays with fewer variables.

In an optional embodiment of the method according to the invention, the sensor system comprises n sensors, each of the n sensors detecting one of the n variables and/or a measurement value from which one of the n variables is determined.

In a refinement of the invention, n>=3. It is therefore particularly possible to display measurement points that have three variables (for n=3) in a two-dimensional coordinate system. The third variable is presented as an optical value.

In a further especially advantageous embodiment of the invention, the optical value range of the n-th variables is a brightness and/or a color coding. Values of the n-th variables are displayed by means of suitable selection of the value range of the n-th variables in the position. Values of the n-th variables for the system that monitors the sensor system can thus be detected and classified quickly and reliably by a user for relevance to the system, which is also true for values of the n-th variables that reach or exceed a critical value for the system, for example.

In a further aspect of the invention, the optical value range comprises at least two values. The values can, for example, be defined in such a way that, in the case of color coding, a first color is displayed for non-critical values of the n-th variables, and a second color is displayed for critical values of the system. Analogously, in the case of brightness coding, for example, one brightness can be displayed for critical values and a second brightness can be displayed for non-critical values.

In a further advantageous embodiment of the invention, a threshold value is assigned to the value range of the measurement values of the n-th variable of the measurement value groups. In an optional refinement of the invention, this threshold value is also transformed into an optical value. In a further embodiment of the invention, the transformed threshold value is identified in the display. In an optional refinement of the invention, the values of the n-th variables of the measurement value groups above the threshold value are assigned a different optical value than the values of the n-th variables of the measurement value groups below the threshold value.

In a further embodiment of the invention, the optical value ranges comprises a continuous spectrum of optical values. The color coding can then comprise, for example, the optically visible spectrum (red to blue), a brightness coding, a grayscale coding from black to white, or a fixed interval within the selected spectrum.

In a further embodiment of the invention, a legend is displayed that shows the assignment of the values of the n-th variables to values of the optical value range. A user can thus quickly and reliably recognize the value of the n-th variables in the (n−1) dimensional coordinate system. In an optional refinement of the invention, the threshold value is identified in the legend.

In a refinement of the invention, n>=4. It is therefore particularly possible to display measurement points that have four variables (for n=4) in a three-dimensional coordinate system. The fourth variable is displayed as an optical value.

In an optional refinement of the method, for variables greater than 4, further optical values or value ranges are used, such as the size of the displayed point, a combination of brightness and color gradient, the thickness of the border of the measurement points, and the shape of the measurement points (e.g. number of corners).

In a further embodiment of the invention, variables 1 to n−1 of the measurement value groups are displayed in a three-dimensional coordinate system. It is therefore particularly possible to display measurement points that have four variables (for n=4) in a three-dimensional coordinate system. The fourth variable n is displayed as an optical value.

In a further advantageous embodiment, the perspective of the display of the three-dimensional coordinate system is changed according to a user input. The display of the measurement values in the coordinate system is advantageously designed in such a way that a user can change the perspective of the display at any time. It is possible, for example, to rotate the display and/or to enlarge or reduce (zoom) the display of the coordinate system in order to highlight specific areas of the display that are of interest to the user.

In a further embodiment of the invention, the respective two-dimensional value pairs are displayed in the three-dimensional coordinate system by means of a projection onto the corresponding coordinate axes. A user can have the two-dimensional value pairs associated with each measurement value displayed by means of a projection onto the corresponding coordinate planes. Dependencies of one variable on just one other variable can thus be represented by projection onto the xy-plane, by projection onto the yz-plane, and by projection onto the xz-plane, and can be quickly grasped by the user.

In a further embodiment of the invention, the points of the measurement value groups are displayed on the surfaces formed by the coordinate axes in the optical values that were assigned to the n-th variables of the measurement value groups. A user can have the two-dimensional value pairs associated with each measurement value displayed together with the optical values of each point in the measurement value groups by means of a projection onto the corresponding coordinate planes. Dependencies of one variable on just one other variable can thus be represented by projection onto the xy-plane, by projection onto the yz-plane, and by projection onto the xz-plane, and can be quickly grasped by the user.

In a further embodiment of the invention, the deviation of a measurement value group from a comparison value is determined. This comparison value can, for example, be a characteristic curve specified by the manufacturer of the monitored installation. A determination of the deviation of the measurement value group from this comparison value is especially relevant for a user, for example, in order to determine faults in the installation monitored by the sensor system or to operate the installation in a cost-effective, low-energy-consuming operating mode.

In an especially advantageous embodiment of the invention, the n-th variable represents the deviation from comparison values. A determination of the deviation of the measurement value group from this comparison value is especially relevant for a user, for example, in order to determine faults in the installation monitored by the sensor system or to operate the installation in a cost-effective, low-energy-consuming operating mode. Due to the display of the n-th variables in an optical value range, a user can immediately and reliably recognize the deviation of the measurement value groups from the comparison values.

In a further embodiment of the invention, the comparison values are displayed in the coordinate system. In this way, a user can immediately and reliably recognize a deviation in the measurement value groups from the comparison values.

In a further aspect of the invention, the comparison values are displayed as lines and/or surfaces in the coordinate system. Depending on the type of coordinate system, the comparison values are lines or surfaces. The comparison values are usually displayed as a one-dimensional line in a two-dimensional coordinate system, whereas they are displayed as a surface in a three-dimensional coordinate system. However, the comparison values can also represent a one-dimensional line in a three-dimensional coordinate system, for example, in order to display the most efficient operating mode.

In a further embodiment of the invention, the deviation is determined in relation to one of variables 1 to n−1 of the measurement value group. The deviation of the measurement value groups from the comparison values is determined for one or more variables and thus enables a user to recognize the dependencies of the deviation from a specific variable. In the event of a fault in the monitored installation, a user is therefore able to identify or isolate the source of the fault.

An embodiment of the invention will be described in greater detail in the following using drawings. The following is shown:

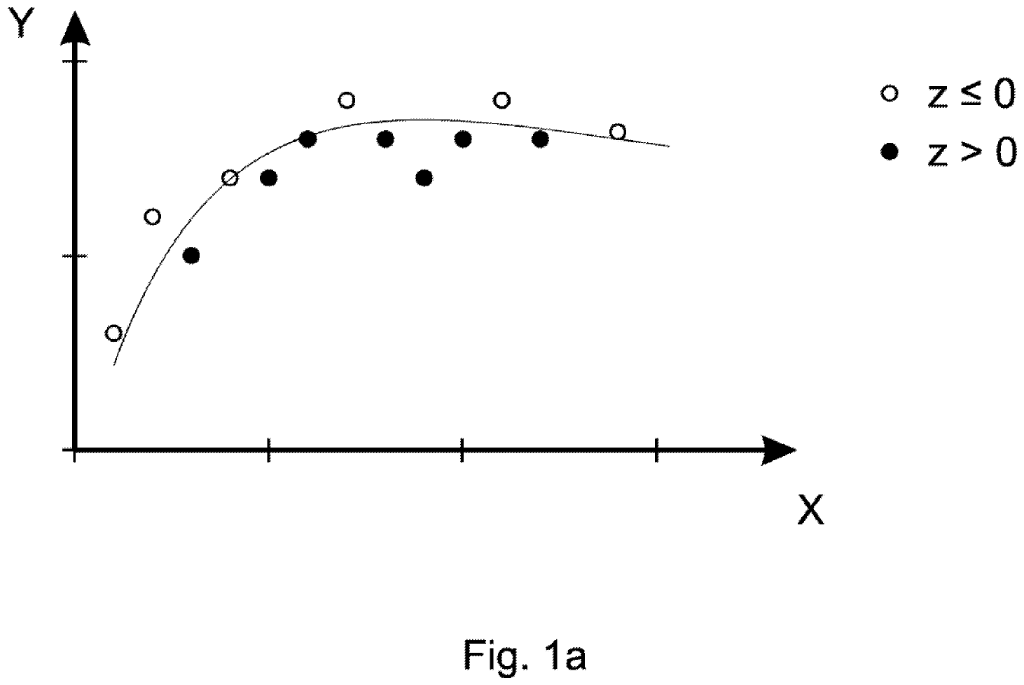

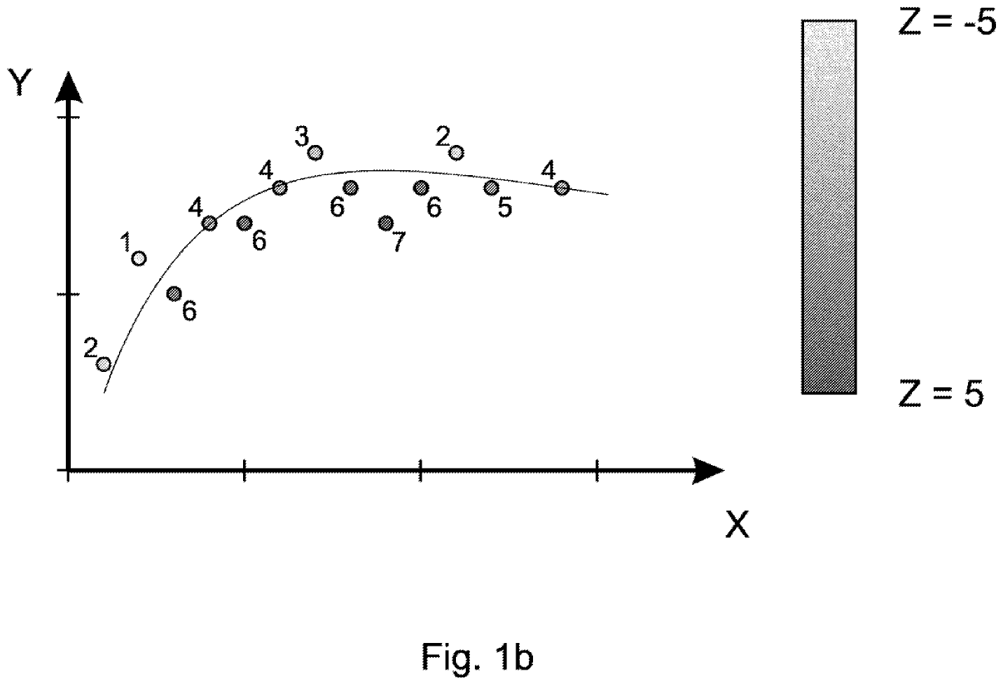

FIG. 1a) two-dimensional coordinate system, measurement values as a function of two variables (x,y), assumed threshold value;

FIG. 1b) two-dimensional coordinate system, measurement values as a function of three variables (x,y,w) in grayscale, threshold values;

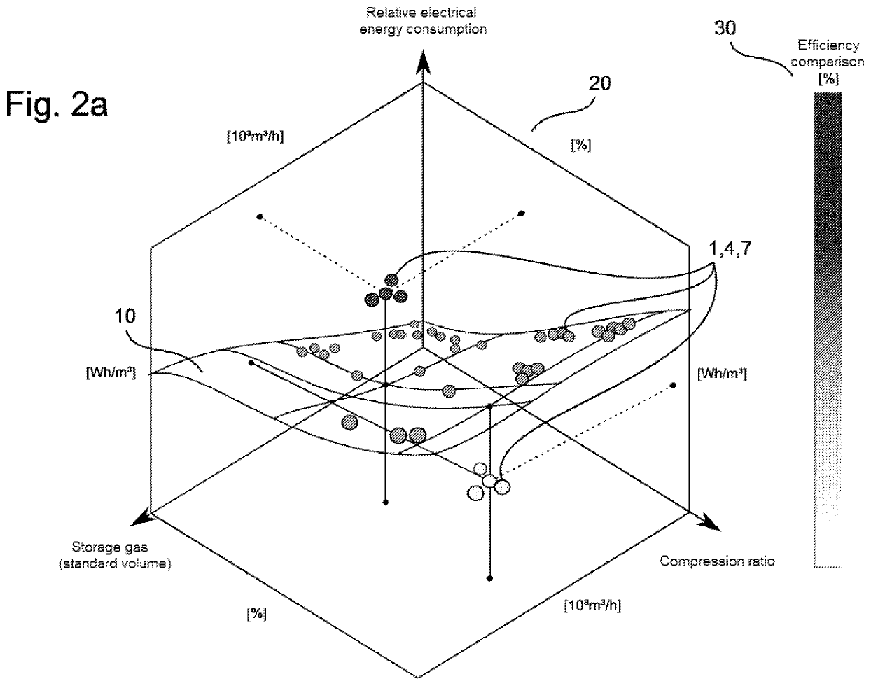

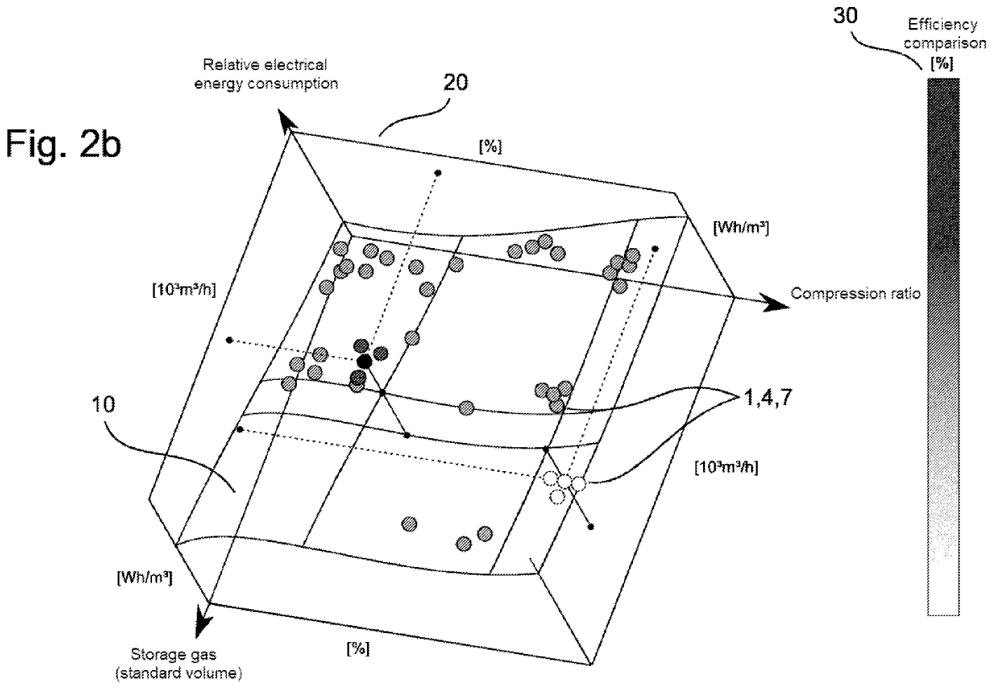

FIG. 2a) Cartesian coordinate system, measurement values as a function of four variables (x,y,z,w) in grayscale with a comparison value surface (threshold value) in a time grid of 7 days—view 1;

FIG. 2b) Cartesian coordinate system, measurement values as a function of four variables (x,y,z,w) in grayscale with a comparison value surface (threshold value) in a time grid of 7 days—view 2;

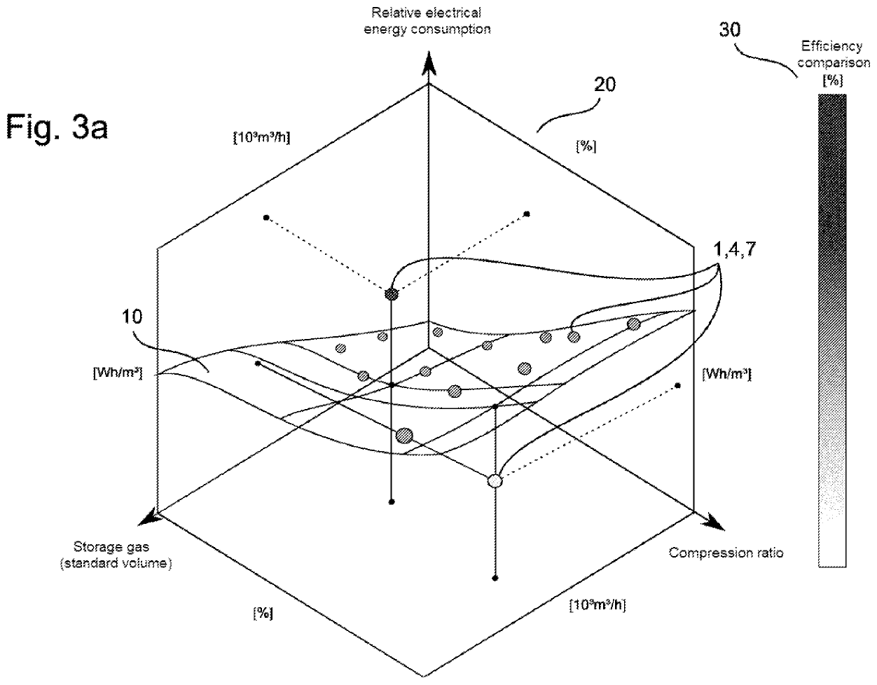

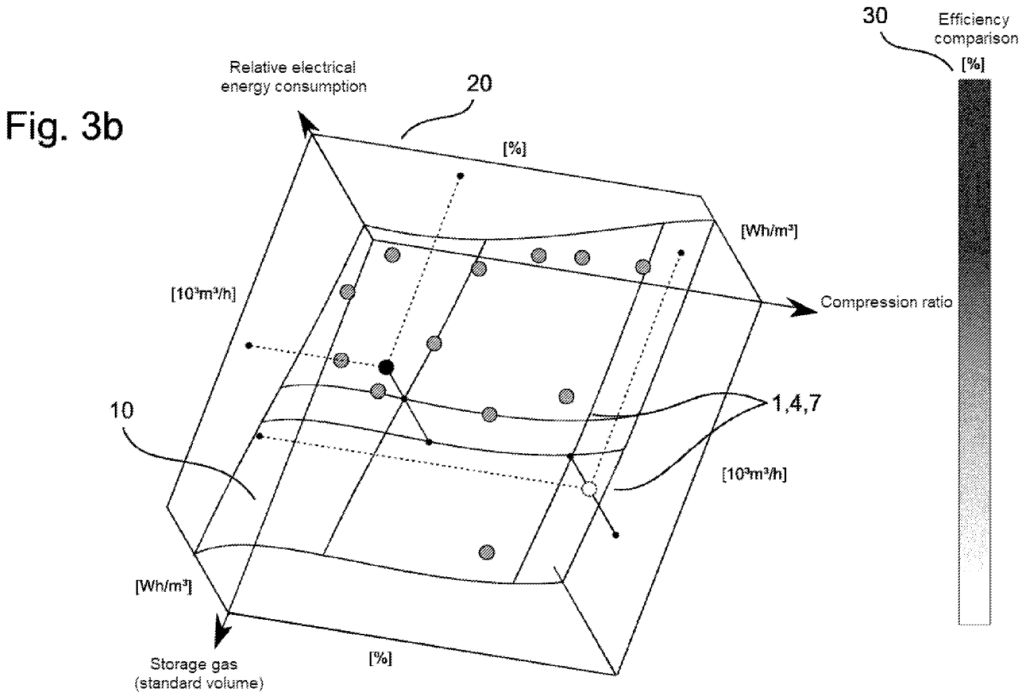

FIG. 3a) Cartesian coordinate system, measurement values as a function of four variables (x,y,z,w) in grayscale with a comparison value surface (threshold value) in a time grid of 3 hours—view 1;

FIG. 3b) Cartesian coordinate system, measurement values as a function of four variables (x,y,z,w) in grayscale with a comparison value surface (threshold value) in a time grid of 3 hours—view 2;

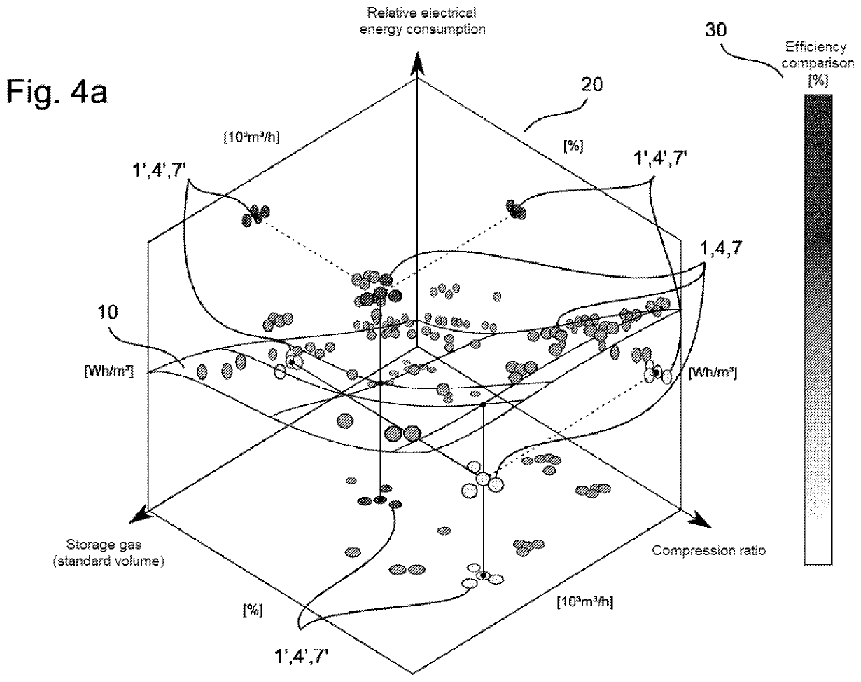

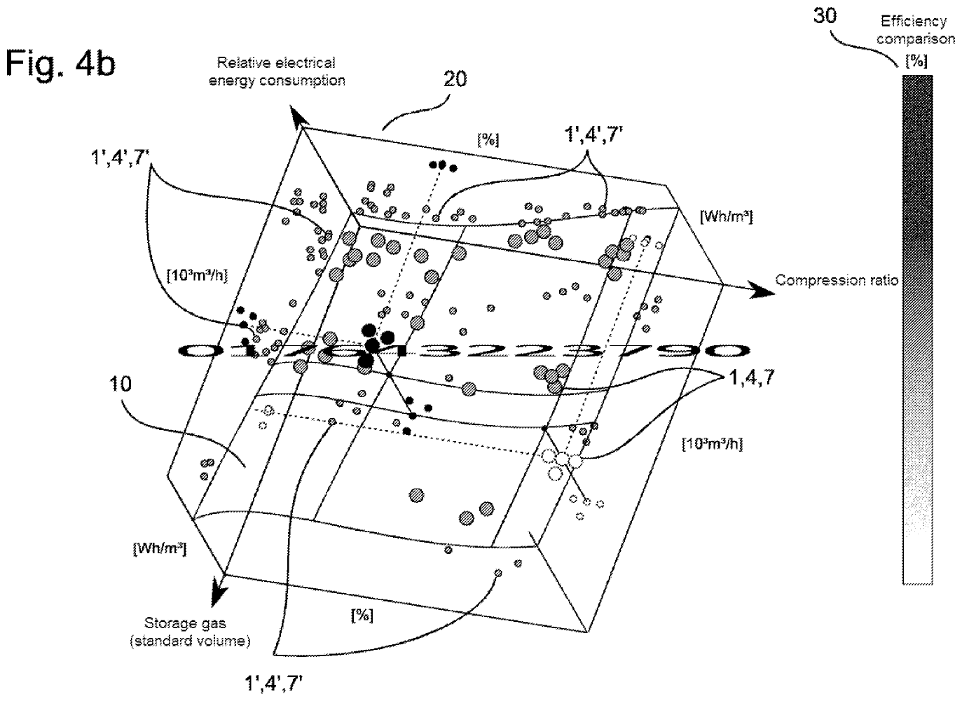

FIG. 4a) Cartesian coordinate system, measurement values as a function of four variables (x,y,z,w) in grayscale with a comparison value surface (threshold value) in a time grid of 1 hour with projection of the measurement values onto the surfaces of the coordinate axes—view 1;

FIG. 4b) Cartesian coordinate system, measurement values as a function of four variables (x,y,z,w) in grayscale with a comparison value surface (threshold value) in a time grid of 1 hour with projection of the measurement values onto the surfaces of the coordinate axes—view 2;

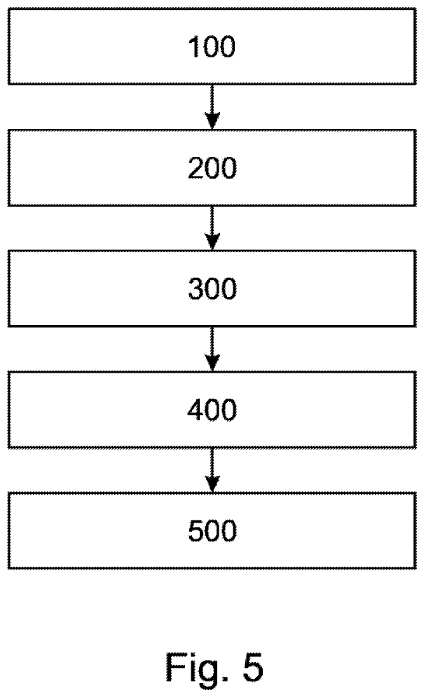

FIG. 5 Sequence of the method according to the invention.

FIG. 1 shows a schematic exemplary embodiment of the method according to the invention, the measurement values 1, 2, 3, 4, 5, 6, 7 of the sensor system being shown in a two-dimensional coordinate system 20.

In this exemplary embodiment, the sensor system with three sensors, which sensor system monitors the installation, provides measurement values 1, 2, 3, 4, 5, 6, 7, which are displayed as points in the two-dimensional coordinate system 20. In this exemplary embodiment, a measurement value 1, 2, 3, 4, 5, 6, 7 consists of the three variables (Y,X,Z). The coordinate axes are denoted as Y (x-axis) and X (y-axis) and only serve to illustrate the general principle of the invention in this exemplary embodiment. In addition, the curve of a comparison value 10 is shown in the coordinate system 20. This comparison value 10 can, for example, be a characteristic curve specified by the manufacturer of the monitored installation. The curve of the comparison value 10 is a one-dimensional curve, a continuous function X=f(Y) in this exemplary embodiment.

In the first method step 100 of the method according to the invention, the sensor data are transmitted to an evaluation unit. The measurement values 1, 2, 3, 4, 5, 6, 7 are automatically transformed into the appropriate value range in the coordinate system 20 in order to be displayed. This transformation can also be carried out at any time and also subsequently by a user in order to adapt the display size of the coordinate system 20 for reasons of clarity. The optical value range of variable Z is defined in the second method step 200 of the method according to the invention, and variable Z is transformed into this optical value range in the third method step 300. In this exemplary embodiment, variable Z represents the deviation of the individual measurement value 1, 2, 3, 4, 5, 6, 7 from the comparison value 10. The optical value range can also be defined automatically and/or by a user and changed for reasons of clarity; for example, color coding is possible. In the fourth method step 400, the measurement values 1, 2, 3, 4, 5, 6, 7 are each displayed as a symbol depending on Y and X in a two-dimensional coordinate system 20. In the fifth method step 500, the symbols of the measurement values 1, 2, 3, 4, 5, 6, 7 are displayed with the respective associated optical value.

In FIG. 1a, deviation Z of a measurement value 1, 2, 3, 4, 5, 6, 7 from the comparison value 10 is shown using two colors: measurement values 1, 2, 3, 4, 5, 6, 7 in which the values of deviation Z from the comparison value 10 are less than or equal to 0 are shown in white; measurement values 1, 2, 3, 4, 5, 6, 7 in which deviation Z is greater than 0 are displayed in black. In addition, a legend 30 is shown, which allows the measurement values to be assigned to the color coding of measurement values 1, 2, 3, 4, 5, 6, 7 or the symbolic representation thereof.

FIG. 1b shows deviation Z of a measurement value 1, 2, 3, 4, 5, 6, 7 from the comparison value 10 in grayscale. Measurement values 1, 2, 3, 4, 5, 6, 7 which show the values of deviation Z from the comparison value 10 equal to (−5) are also shown in white; measurement values 1, 2, 3, 4, 5, 6, 7 the deviation Z of which is equal to 5 are shown in black. The values 1, 2, 3, 4, 5, 6, 7 between these two extreme values are displayed in grayscale. The legend 30 allows the assignment of the measurement values 1, 2, 3, 4, 5, 6, 7 to the color coding of variable Z.

FIG. 2 shows an exemplary embodiment of the method according to the invention using an underground storage facility for natural gas. These storage facilities are used to compensate for imbalances between supply or production and demand or consumption and to increase the reliability of supply. Since the gas in the underground storage facility usually has a higher pressure than the long-distance gas pipeline, the gas is compressed with a compressor in order to supply it.

In this exemplary embodiment, the sensor system that monitors the installation provides sensor data on the feed rate of the natural gas into the storage facility (variable 1, x-axis), on the compression ratio of the compressed natural gas (variable 2, y-axis), and on the relative energy consumption (variable 3, z-axis). In addition, the sensor system provides variable 4, namely a comparison value for energy efficiency, i.e. the amount of energy required per volume of gas fed into the storage facility, which is especially relevant for a user of the installation. A plurality of sensors are required to determine the respective measurement values in order to determine the respective measurement values from the raw data of the sensors. In this exemplary embodiment, the number of sensors and the measurement values therefrom is greater than the number of variables shown in the graphic representation.

In addition, the curve of a comparison value 10 is shown in the coordinate system 20. The comparison values 10 are typically provided by the manufacturer of the monitored installation and are functions of the feed rate, compression ratio, and relative energy consumption. The curve of the comparison value 10 is a two-dimensional surface in this three-dimensional coordinate system 20.

In the first method step 100 of the method according to the invention, the sensor data are transmitted to an evaluation unit. The measurement values 1, 2, 3, 4, 5, 6, 7 are automatically transformed into the appropriate value range in the coordinate system 20 in order to be displayed. This transformation can also be carried out at any time and also subsequently by a user in order to adapt the display size of the coordinate system 20 for reasons of clarity. The optical value range of variable 4 (comparison value of the energy efficiency) is defined in the second method step 200 of the method according to the invention, and variable 4 is transformed into this optical value range in the third method step 300. The optical value range can also be defined automatically and/or by a user and changed for reasons of clarity. In the fourth method step 400, the measurement values 1, 2, 3, 4, 5, 6, 7 are each displayed as a symbol in a three-dimensional coordinate system 20. In the fifth method step 500, the measurement values 1, 2, 3, 4, 5, 6, 7 are displayed with the respective associated optical value. The optical value range is shown in a legend 30 for the assignment of the measurement values 1, 2, 3, 4, 5, 6, 7 to the color coding of the measurement values 1, 2, 3, 4, 5, 6, 7 or the symbolic representation thereof. In this exemplary embodiment, the optical value range is displayed in grayscale. Measurement values 1, 2, 3, 4, 5, 6, 7 which have an especially high comparison value of energy efficiency (>126%) are shown in black; measurement values 1, 2, 3, 4, 5, 6, 7 with a low comparison value of energy efficiency (<90%) are shown in white. Measurement values 1, 2, 3, 4, 5, 6, 7 which have comparison values of energy efficiency between the extreme values mentioned are shown in grayscale with different shades corresponding to the respective values of the energy efficiency comparison values (FIG. 3a).

In terms of the invention, the coordinate system 20 is not limited to a Cartesian coordinate system 20; oblique coordinate systems 20 or spherical coordinates 20 are also conceivable. According to the invention, the display of the measurement values 1, 2, 3, 4, 5, 6, 7 in the coordinate system 20 is designed such that a user can change the perspective of the display at any time. It is possible, for example, to rotate the display (FIG. 3b) and/or to enlarge or reduce (zoom) the display in order to highlight specific regions of the display that are of interest to the user.

FIG. 3 illustrates an exemplary embodiment of the method according to the invention using an underground storage facility for natural gas, in which the method is configured by a user so that the measurement values 1, 2, 3, 4, 5, 6, 7 transmitted by the sensor system are continually updated, or new measurement values 1, 2, 3, 4, 5, 6, 7 are entered into the coordinate system 20 without a noticeable time delay and are displayed in this way. Thus, this exemplary embodiment shows significantly more measurement values 1, 2, 3, 4, 5, 6, 7 than the previous exemplary embodiment.

The method according to the invention therefore makes it possible to optically prepare measurement values 1, 2, 3, 4, 5, 6, 7 of a sensor system for a user in such a way that the user is continually informed about the status of the monitored system, particularly if the user changes one of the variables by making more energy available to the compressor in this exemplary embodiment, for example. The effects of the change can be seen without any noticeable time delay.

The sensor system that monitors the installation provides sensor data on the feed rate of the natural gas into the storage facility (variable 1, x-axis), on the compression ratio of the compressed natural gas (variable 2, y-axis), and on the relative energy consumption (variable 3, z-axis). In addition, the sensor system provides variable 4, namely a comparison value for energy efficiency, i.e. the amount of energy required per volume of gas fed into the storage facility, which is especially relevant for a user of the installation.

In addition, the curve of a comparison value 10 is shown in the coordinate system 20. The comparison values 10 are typically provided by the manufacturer of the monitored installation and are functions of the feed rate, compression ratio, and relative energy consumption. The curve of the comparison value 10 is a two-dimensional surface in this three-dimensional coordinate system 20.

In the first method step 100 of the method according to the invention, the sensor data are transmitted to an evaluation unit. The measurement values 1, 2, 3, 4, 5, 6, 7 are automatically transformed into the appropriate value range in the coordinate system 20 in order to be displayed. This transformation can also be carried out at any time and also subsequently by a user in order to adapt the display size of the coordinate system 20 for reasons of clarity. The optical value range of variable 4 (comparison value of the energy efficiency) is defined in the second method step 200 of the method according to the invention, and variable 4 is transformed into this optical value range in the third method step 300. The optical value range can also be defined automatically and/or by a user and changed for reasons of clarity. In the fourth method step 400, the measurement values 1, 2, 3, 4, 5, 6, 7 are each displayed as a symbol in a three-dimensional coordinate system 20. In the fifth method step 500, the measurement values 1, 2, 3, 4, 5, 6, 7 are displayed with the respective associated optical value. The optical value range is shown in a legend 30 for the assignment of the measurement values 1, 2, 3, 4, 5, 6, 7 to the color coding of the measurement values 1, 2, 3, 4, 5, 6, 7 or the symbolic representation thereof. In this exemplary embodiment, the optical value range is displayed in grayscale. Measurement values 1, 2, 3, 4, 5, 6, 7 which have an especially high comparison value of energy efficiency (>126%) are shown in black; measurement values 1, 2, 3, 4, 5, 6, 7 with a low comparison value of energy efficiency (<90%) are shown in white. Measurement values 1, 2, 3, 4, 5, 6, 7 which have comparison values of energy efficiency between the extreme values mentioned are shown in grayscale with different shades corresponding to the respective values of the energy efficiency comparison values (FIG. 3a).

According to the invention, the measurement values 1, 2, 3, 4, 5, 6, 7 are displayed in the coordinate system 20 in such a way that a user can change the perspective of the display at any time. It is possible, for example, to rotate the display (FIG. 3b) and/or to zoom in the display in order to highlight specific areas of the display that are of interest to the user.

FIG. 4 shows an exemplary embodiment of the method according to the invention using an underground storage facility for natural gas, in which the three-dimensional value triples of the measurement values 1, 2, 3, 4, 5, 6, 7 are projected onto the corresponding surfaces formed by the coordinate axes.

The sensor system that monitors the installation provides sensor data on the feed rate of the natural gas into the storage facility (variable 1, x-axis), on the compression ratio of the compressed natural gas (variable 2, y-axis), and on the relative energy consumption (variable 3, z-axis). In addition, the sensor system provides variable 4, which is especially relevant for a user of the installation, namely a comparison value for energy efficiency, i.e. the amount of energy required per volume of gas fed into the storage facility.

In addition, the curve of a comparison value 10 is shown in the coordinate system 20. The comparison values 10 are typically provided by the manufacturer of the monitored installation and are functions of the feed rate, compression ratio, and relative energy consumption. The curve of the comparison value 10 is a two-dimensional surface in this three-dimensional coordinate system 20.

In the first method step 100 of the method according to the invention, the sensor data are transmitted to an evaluation unit. The measurement values 1, 2, 3, 4, 5, 6, 7 are automatically transformed into the appropriate value range in the coordinate system 20 in order to be displayed. This transformation can also be carried out at any time and also subsequently by a user in order to adapt the display size of the coordinate system 20 for reasons of clarity. The optical value range of variable 4 (comparison value of the energy efficiency) is defined in the second method step 200 of the method according to the invention, and variable 4 is transformed into this optical value range in the third method step 300. The optical value range can also be defined automatically and/or by a user and changed for reasons of clarity. In the fourth method step 400, the measurement values 1, 2, 3, 4, 5, 6, 7 are each displayed as a symbol in a three-dimensional coordinate system 20. In the fifth method step 500, the measurement values 1, 2, 3, 4, 5, 6, 7 are displayed with the respective associated optical value. The optical value range is shown in a legend 30 for the assignment of the measurement values 1, 2, 3, 4, 5, 6, 7 to the color coding of the measurement values 1, 2, 3, 4, 5, 6, 7 or the symbolic representation thereof. In this exemplary embodiment, the optical value range is displayed in grayscale. Measurement values 1, 2, 3, 4, 5, 6, 7 which have an especially high comparison value of energy efficiency (>126%) are shown in black; measurement values 1, 2, 3, 4, 5, 6, 7 with a low comparison value of energy efficiency (<90%) are shown in white. Measurement values 1, 2, 3, 4, 5, 6, 7 which have comparison values of energy efficiency between the extreme values mentioned are shown in grayscale gradients corresponding to their values of the comparison values of energy efficiency (FIG. 4a).

A user can also change the perspective of the display at any time (FIG. 4b); for example, the display can be rotated and/or zoomed in order to highlight specific areas of the display that are of interest to the user.

In the same way, a user can display the two-dimensional value pairs associated with each measurement value 1, 2, 3, 4, 5, 6, 7 by a projection 1′, 2′, 3′, 4′, 5′, 6′, 7′ onto the corresponding coordinate planes. In the present exemplary embodiment, a user can determine the dependency of the standard volume of the storage gas on the compression ratio by projecting onto the xy-plane, determine the compression ratio as a function of the relative energy consumption by projecting onto the yz-plane, and determine the standard volume of the storage gas as a function of the relative energy consumption by projecting onto the xz-plane.

FIG. 5 schematically shows the flowchart of the method according to the invention. In the first method step 100, the sensor data are transmitted to an evaluation unit. The measurement values are automatically transformed into the appropriate value range in the coordinate system 20 in order to be displayed. This transformation can also be carried out at any time and also subsequently by a user in order to adapt the display size of the coordinate system 20 for reasons of clarity. The optical value range of variable Z is defined in the second method step 200 of the method according to the invention, and variable Z is transformed into this optical value range in the third method step 300. The optical value range can also be defined automatically and/or by a user and changed for reasons of clarity; for example, color coding is possible. In the fourth method step 400, the measurement values are each displayed as a symbol with dependency on Y and X in a two-dimensional coordinate system 20. In the fifth method step 500, the symbols of the measurement values are displayed with the respective associated optical value.

### LIST OF REFERENCE NUMERALS

1, 2, 3, 4, 5, 6, 7 Measurement value group
10 Comparison value
20 Coordinate system
30 Legend
   Measurement value group projected onto a coordinate
1′, 2′, 3′, 4′, 5′, 6′, 7′ surface
100 Transmission of the measurement values
200 Definition of the optical value range of the n-th variables Transformation of the values of the n-th variables into the
300 optical values
   Representation of variables 1 to n−1 in a coordinate
400 system
   Representation of the optical values of the measurement
500 values

1. A method for automatically displaying measurement values (1, 2, 3, 4, 5, 6, 7),
which has the following method steps:
transmitting a number of measurement value groups (100) detected by a sensor system,
wherein each measurement value group has n variables,
wherein each of the n variables represents a different physical quantity with respectively different physical units;
specifying an optical value range for the display of the n-th variables (200);
transforming the values of the n-th variables of the measurement value groups into optical values from the optical value range (300);
displaying variables 1 to n−1 of the measurement value groups in a coordinate system (20) with n−1 dimensions (400);
displaying the points of the measurement value groups in the optical values assigned to the n-th variable of the measurement value group (500).

2. The method for automatically displaying measurement values (1, 2, 3, 4, 5, 6, 7) according to claim 1,
characterized in that
the sensor system comprises n sensors, wherein each of the n sensors detects one of the n variables and/or a measurement value, from which one of the n variables is determined.

3. The method for automatically displaying measurement values (1, 2, 3, 4, 5, 6, 7) according to claim 1,
characterized in that
n>=3.

4. The method for automatically displaying measurement values (1, 2, 3, 4, 5, 6, 7) according to claim 1,
characterized in that
the optical value range is a color coding and/or a brightness coding.

5. The method for automatically displaying measurement values (1, 2, 3, 4, 5, 6, 7) according to claim 1,
characterized in that
the optical value range comprises at least two values.

6. The method for automatically displaying measurement values (1, 2, 3, 4, 5, 6, 7) according to claim 5,
characterized in that
the optical value range comprises a continuous spectrum of optical values.

7. The method for automatically displaying measurement values (1, 2, 3, 4, 5, 6, 7) according to claim 1,
characterized in that
a legend (30) is displayed for the assignment of the values of the n-th variables of the measurement value group to values of the optical value range.

8. The method for automatically displaying measurement values (1, 2, 3, 4, 5, 6, 7) according to claim 1,
characterized in that
n>=4.

9. The method for automatically displaying measurement values (1, 2, 3, 4, 5, 6, 7) according to claim 8,
characterized in that
variables 1 to n−1 of the measurement value groups are displayed in a three-dimensional coordinate system (20),
wherein the perspective of the display of the three-dimensional coordinate system (20) is changed according to a user input.

10. The method for automatically displaying measurement values (1, 2, 3, 4, 5, 6, 7) according to claim 7,
characterized in that
the display of the respective two-dimensional value pairs is projected onto the corresponding surfaces formed by the coordinate axes in the three-dimensional coordinate system (20).

11. The method for automatically displaying measurement values (1, 2, 3, 4, 5, 6, 7) according to claim 10,
characterized in that
the points of the measurement value groups are displayed on the surfaces formed by the coordinate axes in the optical values assigned to the n-th variables of the measurement value groups.

12. The method for automatically displaying measurement values (1, 2, 3, 4, 5, 6, 7) according to claim 1,
characterized in that
the deviation of a measurement value group from a comparison value (10) is determined.

13. The method for automatically displaying measurement values (1, 2, 3, 4, 5, 6, 7) according to claim 12,
characterized in that
the n-th variable represents the deviation from comparison values (10).

14. The method for automatically displaying measurement values (1, 2, 3, 4, 5, 6, 7) according to claim 12,
characterized in that
the comparison values (10) are displayed in the coordinate system (20),
wherein
the comparison values (10) are displayed as lines and/or surfaces in the coordinate system (20).

15. The method for automatically displaying measurement values (1, 2, 3, 4, 5, 6, 7) according to claim 12,
characterized in that
the deviation is determined in relation to one of variables 1 to n−1 of the measurement value group.

16. The method for automatically displaying measurement values (1, 2, 3, 4, 5, 6, 7) according to claim 13,
characterized in that
the deviation is determined in relation to one of variables 1 to n−1 of the measurement value group.

17. The method for automatically displaying measurement values (1, 2, 3, 4, 5, 6, 7) according to claim 14,
characterized in that
the deviation is determined in relation to one of variables 1 to n−1 of the measurement value group.
